(19) United States
(12) Patent Application Publication
(10) Pub. No.: US 2026/0287733 A1
(43) Pub. Date: Sep. 24, 2026

(54) MULTI-BLUETOOTH-CHIP CONTROL SYSTEM AND SMART DEVICE

(71) Applicant: Shenzhen Shengzhou Intelligent Equipment R&D Co., Ltd., Shenzhen (CN)

(72) Inventors: Junbin CHEN, Shenzhen (CN); Zhenhuan ZHANG, Shenzhen (CN)

(73) Assignee: Shenzhen Shengzhou Intelligent Equipment R&D Co., Ltd., Shenzhen, GD (CN)

(21) Appl. No.: 19/685,134

(22) Filed: May 22, 2026

Related U.S. Application Data
(63) Continuation of application No. PCT/CN2025/123837, filed on Sep. 25, 2025.

(30) Foreign Application Priority Data
Sep. 25, 2024 (CN) 202411344568.5

(51) Int. Cl. G01S 13/88; G01S 13/72; G01S 13/89

(52) U.S. Cl. CPC G01S 13/886; G01S 13/72; G01S 13/89

(57) ABSTRACT

An outdoor safety monitoring method based on millimeter-wave radar, applied to an electronic device, includes: establishing a pairing relationship and a communication connection between the electronic device and each of at least one detection device; obtaining a detection region range for each of the at least one detection device, wherein each of the at least one detection device comprises a millimeter-wave radar sensor, and the detection region range corresponding to the at least one detection device cooperatively forms a monitoring region range of a protected region; acquiring radar echo data received by the millimeter-wave radar sensor of each detection device; and identifying a target and information of the target based on the radar echo data received by the millimeter-wave radar sensor of each of the at least one detection device, and performing a warning operation according to the target information.

### CROSS REFERENCE TO RELATED APPLICATION

This application is a continuation of International Patent Application No. PCT/CN2025/123837, filed on Sep. 25, 2025, which claims priority of China Patent Application No. 202411344568.5 filed on Sep. 25, 2024. The contents of the above-identified applications are incorporated herein by reference.

### TECHNICAL FIELD

The present invention relates to the field of artificial intelligence technology, particularly to an outdoor safety monitoring method based on millimeter-wave radar, an electronic device and an outdoor safety monitoring system based on millimeter-wave radar.

### DESCRIPTION OF RELATED ART

Currently, most outdoor camping warning systems adopt infrared sensor detection way or visual detection way. The detection way based on infrared sensors is susceptible to environmental interference, such as sunlight, resulting in a relatively high false alarm rate. The visual detection way using visual sensors is also easily affected by environmental factors. Under adverse weather conditions such as night, rainy days, snowy days, and foggy days, the accuracy of target recognition is relatively low, which leads to a high false alarm rate and poor user experience.

### BRIEF SUMMARY OF THE INVENTION

It is desired to provide an improved outdoor safety monitoring method based on millimeter-wave radar, an electronic device and an outdoor safety monitoring system based on millimeter-wave radar.

In one aspect, the present application provides an outdoor safety monitoring method based on millimeter-wave radar. The method is applied to an electronic device and comprises:
establishing a pairing relationship and a communication connection between the electronic device and each of at least one detection device; obtaining a detection region range for each of the at least one detection device, wherein each of the at least one detection device comprises a millimeter-wave radar sensor, and the detection region range corresponding to the at least one detection device cooperatively forms a monitoring region range of a protected region; acquiring radar echo data received by the millimeter-wave radar sensor of each detection device; and identifying a target and information of the target based on the radar echo data received by the millimeter-wave radar sensor of each of the at least one detection device, and performing a warning operation according to the target information.

In another aspect, the present application further provides an electronic device which comprises a memory configured for storing a computer program, and a processor configured to execute the computer program to perform the outdoor safety monitoring method described above.

In a further another aspect, the present application further provides an outdoor safety monitoring system based on millimeter-wave radar, comprising the electronic device described above and at least one detection device including a millimeter-wave radar sensor configured for sending electromagnetic wave signals to a corresponding detection region in which the at least one detection device is located and obtaining radar echo data when a target appears in the corresponding detection region, wherein the electronic device is capable of establishing a pairing relationship and a communication connection with the at least one detection device.

The present application further provides computer program product which comprises a computer program for performing, when executed by a processor, the outdoor safety monitoring method described above.

The present application further provides a non-volatile storage medium configured for storing a computer program for performing, when executed by a processor, the outdoor safety monitoring method described above.

In the embodiments of the present application, a pairing relationship and a communication connection are built between the electronic device and each detection device such that the corresponding detection range of each detection device can be acquired, so as to form an all-round monitoring region around the protected region. Radar echo data received by each detection device is collected. Targets can be identified and information of the targets can be obtained based on the radar echo data. Warning operations can be performed according to the target information of the targets appearing in the detection region of any detection device, thereby realizing all-round outdoor monitoring of the protected region. Furthermore, the target information is identified using radar echo data acquired by millimeter-wave radar with high resolution, excellent anti-interference capability, small size, light weight, and the capability to work under harsh weather conditions. Therefore, the accuracy of warning operation can be improved, and portability is also enhanced.

### BRIEF DESCRIPTION OF THE SEVERAL VIEWS OF THE DRAWINGS

The present invention will be further described below in conjunction with the accompanying drawings and embodiments. In the drawings:

FIG. 1 illustrates an outdoor safety monitoring system based on millimeter-wave radar according to an embodiment of the present application;

FIG. 2 illustrates an electronic device according to an embodiment of the present application;

FIG. 3 illustrates a detection device according to an embodiment of the present application;

FIG. 4 is a flowchart of an outdoor safety monitoring method based on millimeter-wave radar according to an embodiment of the present application;

FIG. 5 illustrates a detection region range corresponding to one detection device according to an embodiment of the present application;

FIG. 6 illustrates setting a detection region range of a detection device according to an embodiment of the present application;

FIG. 7 is a schematic diagram of a virtual map displayed according to an embodiment of the present application;

FIG. 8 is a schematic diagram of an outdoor safety monitoring device based on millimeter-wave radar according to an embodiment of the present application; and

FIG. 9 is a schematic diagram of an electronic device according to an embodiment of the present application.

### DETAILED DESCRIPTION OF THE INVENTION

To provide a clearer understanding of the technical features, objectives, and effects of the present invention, the specific embodiments of the invention are described in detail below with reference to the accompanying drawings.

Unless otherwise defined, all technical and scientific terms used herein have the same meaning as commonly understood by those skilled in the art to which this invention belongs. The terms used in the present invention are only for the purpose of describing specific embodiments and are not intended to limit the scope of protection of the present invention. The term “and/or” used herein includes any and all combinations of one or more of the listed items.

In the following description, the expression “some embodiments” refers to a subset of all possible embodiments. However, it should be understood that “some embodiments” can be the same or different subsets of all possible embodiments and can be combined with each other without conflict.

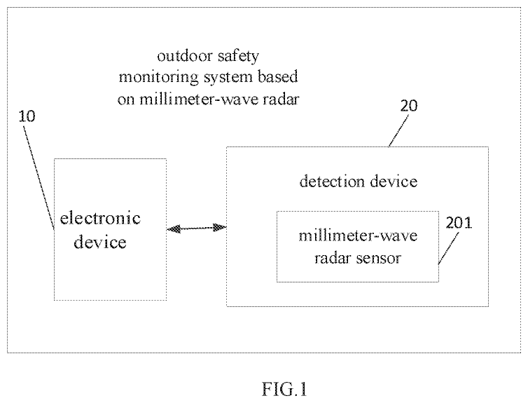

FIG. 1 illustrates an outdoor safety monitoring system based on millimeter-wave radar according to an embodiment of the present disclosure. Referring to FIG. 1, the outdoor safety monitoring system includes an electronic device 10 and at least one detection device 20 which includes a millimeter-wave radar sensor 201. One or more detection devices 20 are respectively arranged around a protected region and configured for acquiring real-time environmental data of detection regions of the one or more detection devices 20 surrounding the protected region to thereby all-round monitor the protected region. The electronic device 10 is configured to identify the target based on the real-time environmental data monitored by each detection device 20 and perform a timely warning operation when a dangerous situation is detected. The protected region refers to the region where the identified target cannot approach, including but not limited to the region where a tent is located, the region where a vehicle is located, the camping region, etc.

The electronic device 10 comprises multiple detection device identifiers, which are corresponding to the detection devices 20 in a one-to-one correspondence. Thus, each detection device 20 can correspond to a detection device identifier.

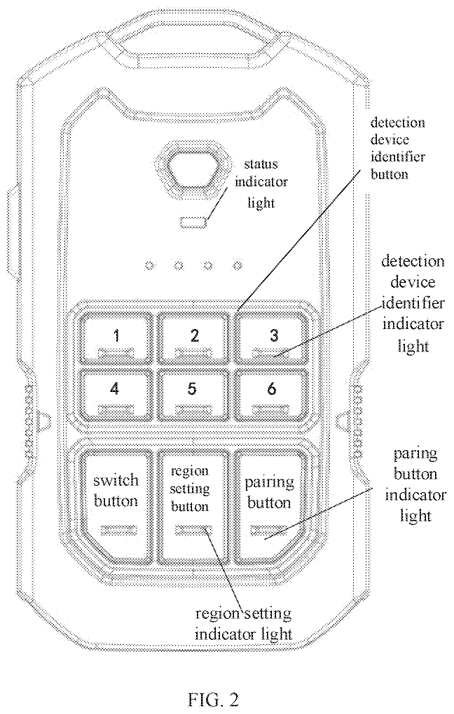

FIG. 2 illustrates an electronic device 10 according to an embodiment of the present disclosure. In FIG. 2, the detection device identifiers are represented by digital numbers 1, 2, 3, 4, 5, 6. Through selection of the number and the pairing button provided on the electronic device 10, the detection devices 20 can be paired with the corresponding detection device identifiers, that is, each detection device 20 can correspond to a corresponding detection device identifier represented by a corresponding digital number. Thus, when the electronic device 10 communicates with multiple detection devices 20 to send data, the detection devices 20 can identified through the corresponding detection device identifiers. The detection region range of each of the detection devices 20 can be determined through the detection device identifier and the region setting button. The electronic device 10 further comprises multiple indicator lights which includes but not limited to status indicator lights, detection device identifier indicator lights, pairing button indicator lights, region setting indicator lights, etc. The indicator lights can perform different prompt operations in different statuses. The prompt operations include but are not limited to: indicating through different colors, indicating through the number of flashes, etc. The detection device identifier, switch button, region setting button, and pairing button can be physical buttons or touch buttons on a user interface, etc., and are not limited herein. The electronic device 10 is not limited to that shown in FIG. 2. The electronic device 10 can also be a device installed with an outdoor safety monitoring program based on millimeter-wave radar, such as computing devices (e.g., desktop computers, laptop computers, tablet computers, handheld computers, smart speakers, servers, etc.), terminal devices (e.g., mobile phones, etc.), wearable devices (e.g., a pair of smart glasses or smart watches), handheld devices, etc. Through the user interface provided by the device installed with the outdoor safety monitoring program based on millimeter-wave radar, the same functions of various buttons in FIG. 2 can be realized.

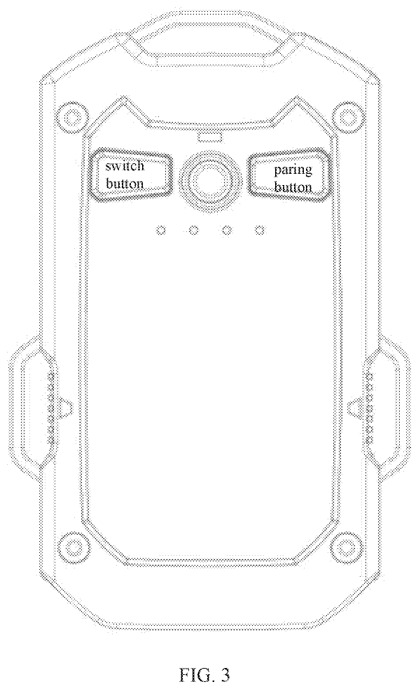

FIG. 3 illustrates a detection device according to an embodiment of the present disclosure. The detection device 20 is provided with a switch button and a pairing button. A pairing request signal can be sent to the electronic device 10 by operating the pairing button. It is understandable that the detection device 20 may also include multiple indicator lights, which can perform different prompt operations in different statuses. The prompt operations include but are not limited to: indicating by displaying different colors, indicating by the number of flashes, etc.

The millimeter-wave radar sensor 201 of each detection device 20 is configured to s end electromagnetic wave signals to the corresponding region in which the detection device 20 is located. When there are targets in the corresponding region, these targets will reflect the electromagnetic wave signals, and the millimeter-wave radar sensor 201 can receive the echo signals reflected by the targets. The electronic device 20 detects the targets in the corresponding region based on the echo signals detected by the millimeter-wave radar sensor 201 of the corresponding detection device 20.

The millimeter-wave radar sensor 201 may be a radar system that uses millimeter-wave band electromagnetic waves to detect targets. The wavelength range of millimeter waves is between 1 mm and 10 mm, between microwave and terahertz waves. The millimeter-wave radar sensor transmits millimeter-wave signals and receives the signals reflected by the targets to obtain information about the targets. The information about the targets includes but is not limited to the distance between the target and the detection device 20, the position data of the target, the radar point cloud data of the target, etc.

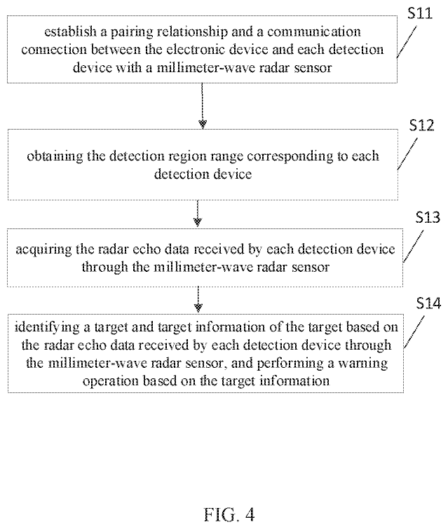

FIG. 4 is a flowchart of the outdoor safety monitoring method based on millimeter-wave radar according to an embodiment of the present application. The outdoor safety monitoring method based on millimeter-wave radar is applied in the electronic device, and the method includes the following steps:

S11: Establish a pairing relationship and a communication connection between the electronic device and the detection devices.

In this embodiment, each detection device generally corresponds to its own detection region range. Multiple detection devices may be used in an outdoor environment. When multiple detection devices are used, there is a need to establish the pairing relationship between each detection device and the electronic device. Through the pairing relationship, a communication connection can be built between the electronic device and the detection devices and the detection devices can be also identified. Thus, when the electronic device receives data, it can identify the detection device that sent the data. The communication connection between the electronic device and the detection devices can be a wireless or wired network connection.

S12: Obtaining the detection region range corresponding to each detection device, wherein each detection device includes a millimeter-wave radar sensor, and the detection region ranges corresponding to one or more detection devices form the monitoring range of the protected region.

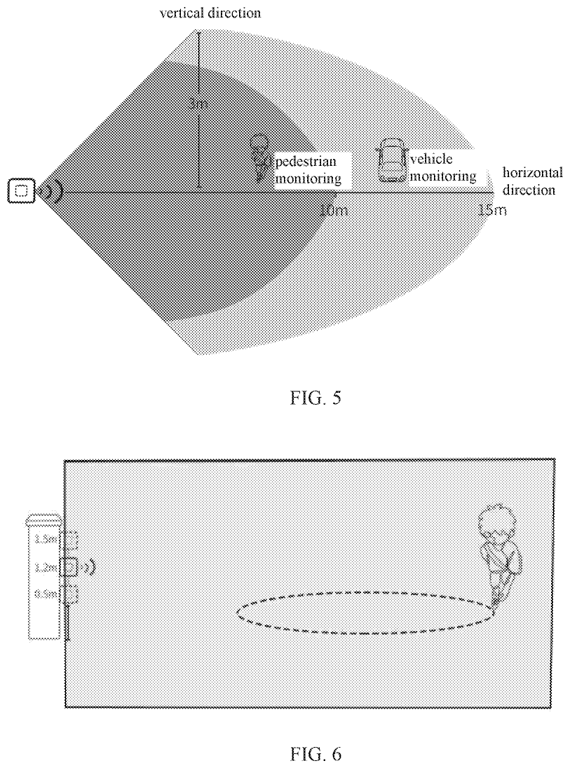

In this embodiment, for a protected region, multiple detection devices can be placed around the protected region, and each detection device corresponds to a detection region range. The detection region ranges corresponding to the detection devices can be intersected or not intersected. Based on the detection region ranges corresponding to multiple detection devices, the monitoring range around the protected region can be formed. Specifically, the regions corresponding to multiple detection devices are spliced to obtain the monitoring range around the protected region. FIG. 5 is a schematic diagram of the detection region range corresponding to one detection device according to an embodiment of the present application. As shown in FIG. 5, the detection region range of one detection device is fan-shaped, and targets within the detection region range can be identified.

S13: Obtain the radar echo data received by each detection device through the millimeter-wave radar sensor.

In this embodiment, each detection device is responsible for detecting within its own detection region range. The millimeter-wave radar sensor in each detection device sends electromagnetic waves to the corresponding detection region range at a preset time interval. When the electromagnetic waves encounter obstacles, the obstacles can reflect echo signals, so the detection device can receive radar echo data. The distance, speed, angle, and other information of the targets can be determined based on the radar echo data.

S14: Identify the target and target information based on the radar echo data received by each detection device through the millimeter-wave radar sensor, and perform a warning operation based on the target information.

In this embodiment, for any detection device, the radar echo data can be preprocessed to obtain preprocessed signal data. The preprocessing includes at least one of the following: static clutter elimination, processing operation based on a mixer, sampling operation based on an analog-to-digital converter, and transformation operation based on fast-time Fourier transform. Preprocessing operations are performed on the echo signals to obtain preprocessed echo data. The preprocessing operations include, but are not limited to, static clutter elimination, processing operation based on a mixer, sampling operation based on an analog-to-digital converter, and transformation operation based on fast-time Fourier transform, etc. Performing static clutter elimination on the radar echo signal/data, can reduce the influence of clutter signals generated by large static objects indoors on the target echo signal. The processing operation based on the mixer mixes the transmitted signal with the echo signal to obtain a signal with a new frequency, which is the intermediate frequency signal. The frequencies and phases of the echo signal and the transmitted signal are different, so the distance, speed, and angle data can be extracted and analyzed from the superimposed intermediate frequency signal. The sampling operation based on the analog-to-digital converter is used to sample the processed echo signal, and the Fourier transform is performed on the sampled signal to obtain a discrete echo signal x(m, n) containing information in the distance dimension and the slow time dimension, where m represents the slow time dimension, which is the mth pulse echo, and n represents the distance dimension, which is the nth distance unit.

Based on the preprocessed signal data, the target recognition algorithm is used to identify the target and determine the target information. The target recognition algorithm includes but is not limited to: the recognition method based on the two-dimensional FFT of the Histogram of Oriented Gradients (HOG) feature, the target recognition based on machine learning algorithms such as Support Vector Machine (SVM) or Convolutional Neural Network (CNN), etc. The target information includes but is not limited to: the speed of the target, the distance of the target, the angle of the target, the position of the target, etc. The target includes but is not limited to: pedestrians, animals, vehicles, etc. For different outdoor environments, the target options corresponding to the outdoor environment can be provided on the user interface, and the target can be configured based on the target options. For example, if a user camps in an area where animals frequently appear, multiple animal categories can be configured as targets on the user interface, which can more accurately identify the target. The warning operation includes but is not limited to one or more of the following combinations: image warning, indicator light warning, voice warning, etc.

In this embodiment, by comparing the transmitted signal and the received signal of the millimeter-wave radar, the flight time (Time of Flight, ToF) or frequency difference of the signal is calculated to determine the distance and moving speed of the target. By using the Doppler effect, the radar can measure the speed of the target. When the target moves towards the radar, the frequency of the echo signal is higher than that of the transmitted signal; when the target moves away from the radar, the frequency of the echo signal is lower than that of the transmitted signal. By calculating the frequency change, the moving speed of the target can be obtained. Millimeter-wave radars typically use antenna arrays to determine the angle of arrival (AoA) of the echo signal. By analyzing the phase difference of the signals received by different antennas in the array, the angle position of the target can be estimated.

In the above embodiment, by establishing a pairing relationship between the electronic device and each detection device, establishing a communication connection between the electronic device and each detection device, and obtaining the corresponding detection region range of each detection device, a comprehensive monitoring range around the protected region is formed. The radar echo data received by each detection device is obtained, and based on the radar echo data received by each detection device, the target is identified and the target information is obtained. The warning operation is performed based on the target information, thereby achieving comprehensive monitoring outdoors. Moreover, since the target information is identified based on the radar echo data obtained by the millimeter-wave radar which has high resolution, good anti-interference ability, small size, light weight, and can work in harsh weather conditions, thus improving the accuracy of the warning and facilitating portability.

In some embodiments, the establishment of the pairing relationship between the electronic device and each detection device includes:

For any detection device, obtaining the pairing request sent by the detection device;

Based on the detection device identifier selection operation corresponding to the detection device and the pairing confirmation operation for pairing with the detection device obtained by the electronic device, sending the pairing confirmation signal corresponding to the pairing confirmation operation and the detection device identifier corresponding to the detection device identifier selection operation to the detection device;

Obtaining the feedback signal of confirmation of successful pairing sent by the detection device.

In this embodiment, the electronic device provides a detection device identifier control and a pairing confirmation control. The user can select the required detection device identifier by triggering the detection device identifier control and confirm entering the pairing status by triggering the pairing confirmation control. It can be understood that the detection device identifier control and the pairing confirmation control can be one or a combination of the following: virtual touch buttons, physical buttons, text boxes, drop-down boxes, check boxes, icons, combo boxes, etc. When the detection device identifier control is triggered, the detection device identifier selection operation is obtained. When the pairing confirmation control is triggered, the pairing confirmation operation is obtained and the pairing status is entered. In this way, the detection device identifier corresponding to the detection device identifier selection operation is sent to the requesting detection device. After receiving the detection device identifier, the requesting detection device sends a feedback signal to the electronic device, thereby establishing the pairing relationship between the electronic device and the requesting detection device. For any detection device, the pairing can be performed according to the above method.

In the above embodiment, by the detection device sending a request and the electronic device sending the corresponding detection device identifier in responsive to the request to the requesting detection device, the pairing between the electronic device and the requesting detection device is achieved, thereby realizing the communication connection between the electronic device and the requesting detection device, which is convenient for subsequent configuration of the detection area of the detection device to facilitate all-round monitoring and protection of the area.

In one optional embodiment, based on the detection device identifier selection operation and the pairing confirmation operation for pairing with the detection device obtained by the electronic device, sending the pairing confirmation signal corresponding to the pairing confirmation operation and the detection device identifier corresponding to the detection device identifier selection operation to the detection device, including:
When the detection device identifier selection operation is obtained, at least one indicator light on the electronic device performs a prompt operation to prompt that the corresponding detection device identifier has been selected;
When the pairing confirmation operation is obtained, at least one indicator light on the electronic device performs a prompt operation to confirm that the pairing status with the detection device has been entered, and the electronic device sends the detection device identifier to the detection device.

Obtaining the feedback signal indicating successful pairing from the detection device includes:
When the feedback signal is obtained by the electronic device, at least one indicator light on the electronic device performs a prompt operation to prompt the user that the pairing relationship between the electronic device and the detection device is built successful.

In this embodiment, as shown in FIG. 2, when a detection device identifier button is clicked, the detection device identifier selection operation is obtained. For example, if the detection device identifier button “2” is clicked, it means that the detection device identifier selection operation indicates that the detection device identifier button “2” has been selected. Then, the detection device identifier indicator light corresponding to the detection device identifier button “2” can flash to prompt the user that the detection device identifier button “2” has been selected. Then, when the pairing button is clicked, the pairing button indicator light can flash yellow to prompt the user that the pairing status with the detection device, which sends the paring request, has been entered. After the electronic device obtains the feedback signal, the pairing button indicator light can prompt in a way different from flashing yellow, such as flashing red, to confirm that the pairing relationship is built between the electronic device and the detection device successful. Thus, the electronic device obtains the pairing confirmation operation.

In the above embodiment, in different task statuses, at least one indicator light is used to prompt the user that different tasks have been entered, thereby enabling the user to understand the pairing process more intuitively and establish a communication connection, and facilitating subsequent configuration of the detection device's monitoring area for comprehensive monitoring and protection of the area.

In some embodiments, obtaining the detection region range corresponding to each of the detection devices includes:
For any of the detection devices, when a selection confirmation operation corresponding to the detection device identifier of the detection device is obtained and a region setting operation is obtained, it is confirmed that the region setting status of the detection device is entered;
Obtain the trajectory data of the user detected by the detection device, and determine the detection region range corresponding to the detection device based on the trajectory data.

In this embodiment, by triggering the detection device identifier control, a selection confirmation operation is obtained. By setting different operations for the detection device identifier control, for example, a short press of the detection device identifier control is for obtaining the detection device identifier selection operation, and a long press of the detection device identifier control is for obtaining the region setting operation. Similarly, for other controls, different trigger ways can be set to correspond to different operations, and the types of controls, as in the above embodiments, can also be diverse control types. The electronic device can also be provided with a region setting control. After the user triggers the region setting control, the electronic device can obtain the region setting operation, and then the electronic device enters the region setting status. As an example, the region setting control can be a region setting button as shown in FIG. 2.

The trajectory data represents the trajectory generated by the user moving from the starting point of a movement path to the ending point of the movement path. The shape of the trajectory includes but is not limited to any type of regular shape, or a combination of multiple regular shapes, etc. FIG. 6 is a schematic diagram showing setting the detection region range of a detection device according to an embodiment. As shown in FIG. 6, for example, after entering the status of setting the detection region range, the user travels at a constant speed within the detection range of the detection device to form trajectory data, and after returning to the starting point, the region setting control can be triggered again, the electronic device obtains the trajectory setting end operation, and then determines the detection region range corresponding to the detection device based on the trajectory data. For other detection devices, the detection region range can be set according to the above method.

In one optional embodiment, obtaining the trajectory data of the trajectory of the user detected by the detection device and determination of the detection region range corresponding to the detection device based on the trajectory data include:
Obtaining the projection point of the detection device on the horizontal plane;
According to the trajectory data, extracting the horizontal maximum point in the horizontal direction, and extracting the vertical minimum point and the vertical maximum point in the vertical direction;
Based on the projection point, the horizontal maximum point, the vertical minimum point and the vertical maximum point, determining the detection region range corresponding to the detection device, wherein the horizontal direction refers to the direction of a horizontal line defined by connecting the projection point of the detection device on the horizontal plane to the center of the trajectory, and the vertical direction is the direction perpendicular to the horizontal direction.

In this embodiment, the horizontal maximum point, the vertical minimum point and the vertical maximum point are boundary points the trajectory of the user. Connecting the projection point with these boundary points can form a detection region range similar to a fan-shaped area as shown in FIG. 5. The horizontal maximum point, the vertical minimum point and the vertical maximum point can be extracted from the trajectory data by using a feature extraction method which includes but is not limited to edge extraction method.

In one optional embodiment, the obtaining of the trajectory data of the user detected by the detection device and the determination of the detection region range corresponding to the detection device based on the trajectory data include:

When the detection region range corresponding to the detection device is not obtained based on the trajectory data, performing a prompt operation through at least one indicator light on the electronic device to prompt that the detection region range setting of the detection device has failed.

In this embodiment, after the electronic device obtains the trajectory setting end operation, the situation where the detection region range corresponding to the detection device is not obtained based on the trajectory data includes but is not limited to not extracting edge points, not extracting all boundary points, etc. When the corresponding detection region range of the detection device is not obtained, the region setting indicator light can be used to prompt that the detection region range setting of the detection device has failed.

In the above embodiment, based on the selection confirmation operation of the detection device identifier corresponding to each detection device and the obtained region setting operation, the region setting status of the detection device can be entered, and then the trajectory data of the user of each detection device can be obtained. According to the trajectory data, the detection region range corresponding to the detection device can be determined, which facilitates the accurate configuration of the detection region range of the detection device, achieving all-round monitoring and protection of the area, and improving the accuracy of early warning.

In some embodiments, identifying the target and target information based on the radar echo data received by each of the detection devices through the millimeter-wave radar sensor, and performing a warning operation based on the target information, including at least one of the following:
When the target is detected based on the radar echo data received by the detection device, at least one indicator light is controlled to perform a warning operation to alert the user that a target is approaching within the detection region range of the detection device;
When the target is detected based on the radar echo data received by the detection device, a category of the target being detected and the warning operation being perform based on the category of the target; wherein different warning operations correspond to different danger levels of the target category, and the higher the danger level, the stronger the warning intensity corresponding to the warning operation;
When the target is detected based on the radar echo data received by the detection device, the region level of the region where the target is located being determined based on the target's position and the warning operation being perform based on the region level of the region where the target is located, wherein different warning operations correspond to different region levels, the higher the region level of the region where the target is located, the closer the region to the protected region, and the stronger the warning intensity corresponding to the warning operation.

In an optional embodiment, a warning operation is performed when a target is detected within the detection range of the detection device. For example, if a target is detected within the detection range of detection device A, the detection device identifier indicator light of detection device A can be controlled to provide a prompt, such as continuous flashing to alert the user that a target has appeared in the detection range of detection device A. In an optional embodiment, when the target is identified, the target category can also be identified, for example, by using a pre-trained target detection model to identify the target category. Different category sample targets are used to form a training data set, and the target detection model is trained using the training data set. The danger level of each target category is preset and configured. Different warnings correspond to different target categories in a one-to-one correspondence. When the target category is identified, a warning according to the danger level of the target category is given. In this way, users within the protected region can clearly understand the dangerous status outside the protected region, thereby improving the accuracy of the warning. In an optional implementation, the area surrounding the protected region can be divided into different monitoring regions with different radius lengths centered on the protected region. The closer the region is to the center point, the higher the region level is. In this way, as the target gradually approaches the protected region, different intensity warnings are given to remind the user.

In the above embodiments, when a target is identified within the detection region of the detection device, a timely warning is given, or different warnings are given based on the danger level of the target, or different warnings are given based on the distance of the target from the protected region, so that users within the protected region can promptly understand the status of the target outside the protected region, improve the accuracy of the warning, and thereby enhance outdoor safety.

In some embodiments, the method further includes:
For any of the detection devices, deleting the pairing relationship between the detection device and the electronic device;
The deleting of the pairing relationship between the detection device and the electronic device includes:

When obtaining the detection device identifier selection operation, performing a prompt operation through at least one indicator light on the electronic device to prompt that the detection device identifier has been selected;

When obtaining the deletion confirmation operation, confirming the entry into the deletion status of deleting the pairing relationship between the detection device and the electronic device, and sending the deletion signal corresponding to the deletion status to the detection device;

After obtaining the successful deletion signal fed back by the detection device, confirming that the deletion of the pairing relationship between the detection device and the electronic device is successful.

In this embodiment, when a user needs to delete the pairing relationship between the electronic device and a specific detection device, the detection device identifier selection operation can also be obtained through the detection device identifier control corresponding to the specific detection device, and the deletion confirmation operation can be obtained by triggering the pairing key, so that the specific detection device enters the deletion status, thereby sending the deletion signal of the pairing relationship to the specific detection device corresponding to the detection device identifier selection operation, thereby achieving the deletion of the pairing relationship.

In the above embodiments, the pairing relationship between the detection device and the electronic device can be deleted according to the demand, thereby flexibly setting the monitoring region around the protected region and improving the user experience.

In some embodiments, identifying the target and target information based on the radar echo data received by the detection devices through the millimeter-wave radar sensors, and performing a warning operation based on the target information, including:
Establishing a virtual map based on each of the detection regions corresponding to the detection devices and displaying the virtual map on the user interface;
When a target is detected based on the radar echo data received by the detection device, the real-time movement trajectory of the target is displayed in real time on the virtual map based on the real-time radar echo data received by the detection device;

When the movement trajectory of the target indicates that the target is approaching the protected region, a warning operation is performed.

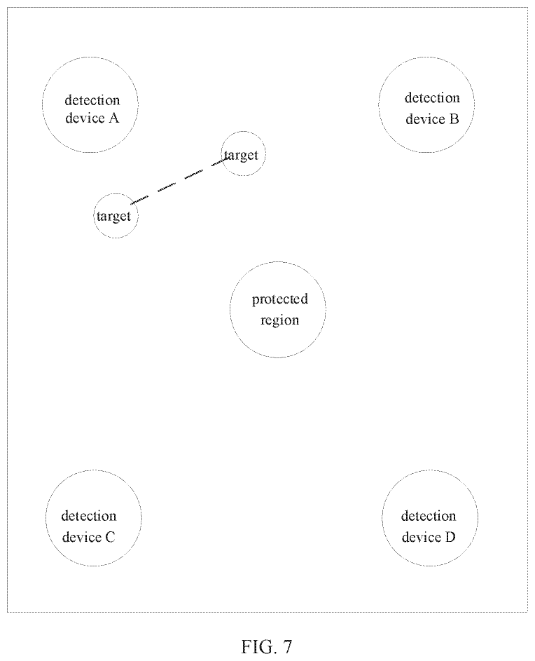

In this embodiment, since the detection devices are arranged based on the protected region, a virtual map can be established based on the detection region range and installation orientation of the detection devices and the position of the protected region. The methods for establishing the virtual map include, but are not limited to, Simultaneous Localization and Mapping (SLAM) algorithms. The forms of the virtual map include, but are not limited to, grid maps, etc. After establishing the virtual map, it can be visually displayed. FIG. 7 is a schematic diagram of the display of a virtual map according to an embodiment. As shown in FIG. 7, on the virtual map, the position of the protected region, the position of the target, and the position of each detection device relative to the protected region can be displayed. The real-time movement trajectory of the target can also be tracked using the real-time received radar echo data and the radar tracking algorithm, and displayed on the virtual map. In this way, users can clearly know the movement of the target outside the protected region through the user interface, improving outdoor safety. The tracked movement trajectory of the target can also be predicted to determine whether the target is approaching or moving away from the protected region. When the tracked movement trajectory indicates that the target is approaching the protected region, a warning operation is performed, thereby providing early warning. The methods for predicting the trajectory include, but are not limited to, Kalman filtering algorithms.

In the above embodiments, a virtual map can be established based on each of the detection regions corresponding to the detection devices and the virtual map is visualized. The movement trajectory of a target outside the protection area can be clearly acquired through the displayed virtual map, so as to effectively enhance outdoor safety.

In another aspect, the present application provides a computer program product, including a computer program, which, when executed by a processor, implements the outdoor safety monitoring method based on millimeter-wave radar as described in any embodiment of this application.

Wherein, in the computer program product, the optional implementation form of the program module architecture of the computer program for implementing each step of the target recognition method can be an outdoor safety monitoring device based on millimeter-wave radar.

Referring to FIG. 8, the present application further provides an outdoor safety monitoring device based on millimeter-wave radar. The device includes a building module 81, an acquisition module 82 and a warning module 83. The building module 81 is configured for establishing a pairing relationship between the electronic device and each detection device, and establishing a communication connection between the electronic device and each detection device, wherein the number of the detection device is one or multiple. The acquisition module 82 is configured for obtaining the detection region range corresponding to each detection device, wherein each detection device includes a millimeter-wave radar sensor, and the detection regions corresponding to the one or multiple detection devices cooperatively form the monitoring region of the protection area; the acquisition module 82 is also configured for obtaining the radar echo data received by each detection device through the millimeter-wave radar sensor. The warning module 83 is configured for identifying the target and target information based on the radar echo data received by the detection devices through the millimeter-wave radar sensor, and performing a warning operation based on the target information.

Optionally, the building module 81 is further configured for obtaining the pairing request sent by any detection device;

Based on the detection device identifier selection operation corresponding to the detection device and the pairing confirmation operation for pairing with the detection device obtained by the electronic device, sending the pairing confirmation signal corresponding to the pairing confirmation operation and the detection device identifier corresponding to the detection device identifier selection operation to the detection device;

Obtaining the feedback signal of successful pairing sent by the detection device.

Optionally, the building module 81 is further configured for:
When obtaining the detection device identifier selection operation, performing a prompt operation through at least one indicator light on the electronic device to prompt that the detection device identifier has been selected;
When obtaining the pairing confirmation operation, performing a prompt operation through at least one indicator light on the electronic device to confirm entering the pairing status with the detection device, and sending the detection device identifier to the detection device;

The obtaining of the feedback signal of successful pairing sent by the detection device includes:
When obtaining the feedback signal, performing a prompt operation through at least one indicator light on the electronic device to prompt the user that the pairing is successful.

Optionally, the acquisition module 82 is further configured for:
For any detection device, when obtaining the selection confirmation operation of the detection device identifier corresponding to the detection device and obtaining the region setting operation, confirming entering the region setting status of the detection device;
Obtaining the trajectory data of the user detected by the detection device, and determining the range of detection region corresponding to the detection device based on the trajectory data.

Optionally, the acquisition module 82 is further configured for:
Obtaining the projection point of the detection device on the horizontal plane;

According to the trajectory data, extracting the horizontal maximum point in the horizontal direction, and extracting the vertical minimum point and the vertical maximum point in the vertical direction;

Based on the projection point, the horizontal maximum point, the vertical minimum point and the vertical maximum point, determining the range of the detection region corresponding to the detection device, where the horizontal direction indicates the direction of the horizontal line established based on the projection point of the detection device on the horizontal plane, and the vertical direction is the direction perpendicular to the horizontal direction.

Optionally, the acquisition module 82 is further configured for:
When the range of the detection region corresponding to the detection device is not obtained based on the trajectory data, performing a prompt operation through at least one indicator light on the electronic device to prompt that the setting of the detection region range setting of the detection device has failed.

Optionally, the warning module 83 is further configured for:
When a target is detected based on the radar echo data received by the detection device, controlling at least one indicator light to perform a warning operation to alert the user that there is a target approaching within the detection region of the detection device;

When a target is detected based on the radar echo data received by the detection device and the target category is detected, performing different warning operations according to the danger level of the target category, wherein the higher the danger level is, the stronger the warning operation is;
When a target is detected based on the radar echo data received by the detection device, determining the level of the region where the target is located based on the target's position, and performing different warning operations in different regions with different levels, wherein the higher the level of the region is, the closer it is to the protected region, and the stronger the corresponding warning operation is.

Optionally, the warning module 83 is further configured for:
For any of the detection devices, deleting the pairing relationship between the detection device and the electronic device;

The deletion of the pairing relationship between the detection device and the electronic device includes:
When an operation to select the detection device identifier is obtained, performing a prompt operation through at least one indicator light on the electronic device to indicate that the detection device identifier has been selected;
When a deletion confirmation operation is obtained, confirming entry into the deletion status of deleting the pairing relationship between the detection device and the electronic device and sending a deletion signal corresponding to the deletion status to the detection device;
After a signal of successful deletion is obtained, confirming that the pairing relationship between the detection device and the electronic device has been successfully deleted.

Optionally, the warning module 83 is further configured for:
Establishing a virtual map based on the detection region range corresponding to each of the detection devices and displaying the virtual map on the user interface;
When a target is detected based on the radar echo data received by the detection devices, displaying the real-time movement trajectory of the target on the virtual map based on the real-time radar echo data received by the detection devices;
When the movement trajectory of the target indicates that the target is approaching the protected region, performing a warning operation.

It should be understood by those skilled in the art that the structure of the outdoor safety monitoring device based on millimeter-wave radar shown in FIG. 8 does not limit the outdoor safety monitoring device based on millimeter-wave radar. Each of the modules can be implemented entirely or partially through software, hardware, or a combination thereof. The above-mentioned modules can be embedded in or independent of the processor in the computer device in the form of hardware, or stored in the memory of the computer device in the form of software, so that the processor can call and execute the corresponding operations of each module. In other embodiments, the outdoor safety monitoring device based on millimeter-wave radar may include more or fewer modules than those shown in the figure.

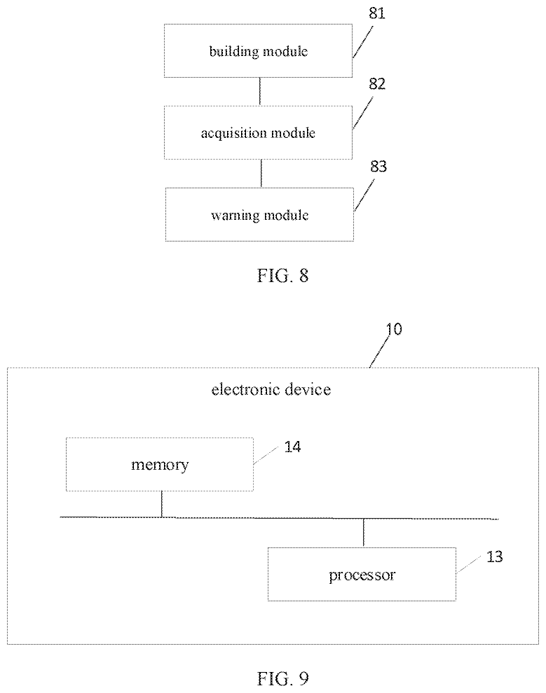

Referring to FIG. 9, in another aspect, the present application further provides an electronic device 10 which includes a processor 13 and a memory 14. The memory 14 stores a computer program. When the computer program is executed by the processor 13, the processor 13 performs the steps of the outdoor safety monitoring method based on millimeter-wave radar described in any of the above embodiments. The electronic device 10 may include computing devices (such as desktop computers, laptop computers, tablet computers, handheld computers, smart speakers, servers, etc.), terminal devices (such as mobile phones, etc.), wearable devices (such as a pair of smart glasses or smart watches), handheld devices, or similar devices.

The processor 13 is a control center which connects all parts of the computer device through various interfaces and lines. By running or executing the software programs and/or modules stored in the memory 14 and calling the data stored in the memory 14, the processor 13 is capable of performing various functions and processing data of the computer device. Optionally, the processor 13 may include one or more processing cores; preferably, the processor 13 may integrate an application processor and a modem processor, where the application processor is mainly configured to process the operating system, user pages, and applications, and the modem processor is mainly configured to perform wireless communication. It should be understood that the above-mentioned modem processor may not be integrated into the processor 13.

The memory 14 can be used to store software programs and modules. The processor 13 is capable of running the software programs and modules stored in the memory 1 4 to perform various functional applications and data processing. The memory 14 mainly includes a program storage area and a data storage area. The program storage area may store the operating system and application programs required for at least one function (such as audio playback function, image playback function, etc.). The data storage area may store data created during the use of the computer device. In addition, the memory 14 may include high-speed random access memory and may also include non-volatile memory, such as at least one magnetic disk storage device, a flash memory device, or other non-volatile solid-status storage devices. Correspondingly, the memory 14 may also include a memory processor to provide the processor 13 with access to the memory 14.

In another aspect of the present application, a non-volatile storage medium configured for storing a computer program is provided. The processor is configured to execute the computer program to perform the steps of the outdoor safety monitoring method based on millimeter-wave radar provided in any of the above embodiments.

Another aspect of the embodiments of the present application provides an outdoor safety monitoring system based on millimeter-wave radar, which includes an electronic device as described in any of the embodiments of the present application and at least one detection device. The electronic device can establish a pairing relationship with the detection device to establish a communication connection. The detection device includes a millimeter-wave radar sensor. The detection device is capable of performing detection within the corresponding detection region of the detection device through the millimeter-wave radar sensor and acquiring radar echo data.

Those skilled in the art can understand that all or part of the processes/steps of the methods provided by the above embodiments can be implemented by instructing relevant hardware through a computer program. The program can be stored in a non-volatile computer-readable storage medium. The program can be executed to perform the processes of the above-described methods. Among them, any reference to a memory, storage, database or other medium in the embodiments provided by the present application may include non-volatile and/or volatile memory. Non-volatile memory may include read-only memory (ROM), programmable ROM (PROM), erasable programmable ROM (EPROM), electrically erasable programmable ROM (EEPROM), or flash memory. Volatile memory may include random access memory (RAM) or external cache memory. As an illustration rather than a limitation, RAM is available in various forms, such as static RAM (SRAM), dynamic RAM (DRAM), synchronous DRAM (SDRAM), double data rate SDRAM (DDR SDRAM), enhanced SDRAM (ESDRAM), synchronous link DRAM (SLDRAM), Rambus direct RAM (RDRAM), direct Rambus dynamic RAM (DRDRAM), and Rambus dynamic RAM (RDRAM), etc.

The above embodiments are merely intended to illustrate the technical concepts and features of the present invention, aiming to enable those skilled in the art to understand the content of the invention and implement it accordingly. They are not intended to limit the scope of protection of the present invention. Any equivalent modifications or variations made within the scope of the claims of the present invention shall fall within the coverage of the claims of the present invention.

What is claimed is:

1. An outdoor safety monitoring method based on millimeter-wave radar, applied to an outdoor safety monitoring system including an electronic device and at least one detection device, the method comprising:
establishing a pairing relationship and a communication connection between the electronic device and each of the at least one detection device, wherein each of the at least one detection device comprises a millimeter-wave radar sensor;
obtaining a detection region range for each of the at least one detection device;
acquiring radar echo data received by any of the at least one detection device via the millimeter-wave radar sensor thereof; and
identifying a target and information of the target based on the radar echo data and performing a warning operation according to the target information.

2. The outdoor safety monitoring method according to claim 1, wherein the at least one detection device comprises multiple detection devices, and the detection region ranges corresponding to the multiple detection devices cooperatively form a monitoring region range around a protected region.

3. The outdoor safety monitoring method according to claim 1, wherein establishing a pairing relationship and a communication connection between the electronic device and each of the at least one detection device comprises:
obtaining a pairing request sent by one of the at least one detection device;
based on a detection device identifier selection operation corresponding to said one of the at least one detection device and a pairing confirmation operation obtained by the electronic device, sending a pairing confirmation signal corresponding to the pairing confirmation operation and a detection device identifier corresponding to the detection device identifier selection operation to the detection device; and
obtaining a feedback signal of confirmation of successful pairing sent by said one of the at least one detection device.

4. The outdoor safety monitoring method according to claim 3, wherein based on a detection device identifier selection operation corresponding to said one of the at least one detection device and a pairing confirmation operation obtained by the electronic device, sending a pairing confirmation signal corresponding to the pairing confirmation operation and a detection device identifier corresponding to the detection device identifier selection operation to the detection device comprises:
when the detection device identifier selection operation is obtained, at least one indicator light on the electronic device performing a prompt operation to prompt that the detection device identifier has been selected;
when the pairing confirmation operation is obtained, at least one another indicator light on the electronic device performing another prompt operation to confirm that a pairing status has been entered, and the electronic device sending the detection device identifier to the detection device.

5. The outdoor safety monitoring method according to claim 4, wherein obtaining a feedback signal indicating successful pairing sent by said one of the at least one detection device includes:
when the feedback signal is obtained by the electronic device, at least one further another indicator light on the electronic device performs further another prompt operation to prompt that the pairing relationship is built between the electronic device and said one of the at least one detection device successfully.

6. The outdoor safety monitoring method according to claim 1, wherein obtaining a detection region range for each of the at least one detection device includes:
when a selection confirmation operation corresponding to a detection device identifier of one of the at least one detection device is obtained and a region setting operation is obtained, confirming that said one of the at least one detection device enters into a region setting status;
obtaining a trajectory data of a user detected by said one of the at least one detection device, and determining the detection region range corresponding to said one of the at least one detection device based on the trajectory data.

7. The outdoor safety monitoring method according to claim 6, wherein obtaining a trajectory data of a user detected by said one of the at least one detection device, and determining the detection region range corresponding to said one of the at least one detection device based on the trajectory data comprises:
obtaining a projection point of said one of the at least one detection device on a horizontal plane;
extracting a horizontal maximum point in a horizontal direction and extracting a vertical minimum point and a vertical maximum point in a vertical direction according to the trajectory data;
determining the detection region range corresponding to said one of the at least one detection device based on the projection point, the horizontal maximum point, the vertical minimum point and the vertical maximum point, wherein the horizontal direction refers to a direction of a horizontal line passing through the projection point of the detection device on the horizontal plane, and the vertical direction refer to a direction perpendicular to the horizontal direction.

8. The outdoor safety monitoring method according to claim 6, wherein obtaining a trajectory data of a user detected by said one of the at least one detection device, and determining the detection region range corresponding to said one of the at least one detection device based on the trajectory data comprises:
performing a prompt operation through at least one indicator light on said one of the at least one detection device to prompt that the detection region range setting of said one of the at least one detection device has failed when the detection region range corresponding to said one of the at least one detection device is not obtained based on the trajectory data.

9. The outdoor safety monitoring method according to claim 1, wherein identifying a target and information of the target based on the radar echo data received by the millimeter-wave radar sensor of one of the at least one detection device, and performing a warning operation according to the target information comprises at least one of:
when the target is detected based on the radar echo data received by said one of the at least one detection device, at least one indicator light being controlled to perform a warning operation to alert the user that the target is approaching within the detection region range of said one of the at least one detection device;
when the target is detected based on the radar echo data received by said one of the at least one detection device, a category of the target being detected and the warning operation being performed according to a danger level of the category of the target, wherein the higher the danger level is, the stronger a warning intensity corresponding to the warning operation is; and
when the target is detected based on the radar echo data received by said one of the at least one detection device, a region level of a region where the target is located being determined based on a position of the target and performing the warning operation corresponding to the level of the region where the target is located, wherein different warning operations correspond to different region levels, and the higher the region level of the region is, the closer the region is to the protected region, and the stronger a warning intensity corresponding to the warning operation is.

10. The outdoor safety monitoring method according to claim 1, further comprising: deleting the pairing relationship between the detection device and one of the at least one electronic device.

11. The outdoor safety monitoring method according to claim 10, wherein deleting the pairing relationship between the detection device and one of the at least one electronic device includes:
when obtaining a detection device identifier selection operation, performing a prompt operation through at least one indicator light on said one of the at least one electronic device to prompt that a detection device identifier has been selected;
when obtaining a deletion confirmation operation, confirming entry into a deletion status of deleting the pairing relationship between the detection device and said one of the at least one electronic device, and sending a deletion signal corresponding to the deletion status to said one of the at least one detection device; and
after obtaining the deletion signal fed back by said one of the at least one detection device, confirming that the pairing relationship between the detection device and the electronic device is deleted successful.

12. The outdoor safety monitoring method according to claim 1, wherein identifying the target and target information based on the radar echo data received by the detection devices through the millimeter-wave radar sensors, and performing a warning operation based on the target information, comprises:
establishing a virtual map based on each of the detection region ranges corresponding to the detection devices and displaying the virtual map on the user interface;
when a target is detected based on the radar echo data received by the detection device, the real-time movement trajectory of the target is displayed in real time on the virtual map based on the real-time radar echo data received by the detection device;
when the movement trajectory of the target indicates that the target is approaching the protected region, a warning operation is performed.

13. An electronic device comprising a memory configured for storing a computer program, and a processor configured to execute the computer program to perform the outdoor safety monitoring method of claim 1.

14. An outdoor safety monitoring system based on millimeter-wave radar, comprising the electronic device of claim 13 and at least one detection device including a millimeter-wave radar sensor configured for sending electromagnetic wave signals to a corresponding detection region range in which the at least one detection device is located and obtaining radar echo data when a target appears in the corresponding detection region range, wherein the electronic device is capable of establishing a pairing relationship and a communication connection with the at least one detection device.

15. The outdoor safety monitoring system according to claim 14, wherein the electronic device comprises multiple detection device identifiers, the at least one detection device comprises multiple detection devices which correspond to the detection devices in a one-to-one correspondence.

16. A computer program product, comprising a computer program for performing, when executed by a processor, the outdoor safety monitoring method according to claim 1.

17. A non-volatile storage medium, configured for storing a computer program for performing, when executed by a processor, the outdoor safety monitoring method according to claim 1.
